(19) United States
(12) Patent Application Publication
(10) Pub. No.: US 2025/0216032 A1
(43) Pub. Date: Jul. 3, 2025

(54) SELF-SUPPLIED HYDROGEN TUBE TRAILER

(71) Applicant: EVERFUEL EUROPE A/S, Herning (DK)

(72) Inventors: Magnus Haugaard RØNNE, Herning (DK); Janus Lindal RATHKE, viborg (DK); Uffe Vikøren BORUP, Sydals (DK)

(21) Appl. No.: 18/850,740

(22) PCT Filed: Mar. 22, 2023
(86) PCT No.: PCT/DK2023/050050

§ 371 Date: Sep. 25, 2024

(30) Foreign Application Priority Data
Mar. 25, 2022 (DK) PA 2022 70140

(51) Int. Cl. F17C 5/06; B60L 53/53; B60L 53/54

(52) U.S. Cl. CPC F17C 5/06; B60L 53/53; B60L 53/54; F17C 2205/0142; F17C 2205/0146; F17C 2221/012; F17C 2223/0123; F17C 2265/065; F17C 2270/0171; F17C 2270/0184

(57) ABSTRACT

The invention relates to a tube trailer comprising: a first hydrogen gas source comprising gaseous hydrogen, a second hydrogen gas source comprising gaseous hydrogen, a controller, an outlet connection, and a fuel cell. Wherein said first and said second hydrogen gas sources, are fluidly connectable to said outlet connection and to said fuel cell via a conduit system, thereby facilitating refueling a receiving vessel, when connected to said outlet connection, and energy production by said fuel cell, and wherein said fuel cell is electrically connectable to an electric load thereby facilitating supply of electric power to said electric load, when electrically connected to said fuel cell. Wherein said controller is configured to establish a flow of said gaseous hydrogen in said conduit system from said first hydrogen gas sources to said fuel cell when the pressure in said first hydrogen gas source is below a dispensing threshold pressure.

### FIELD OF THE INVENTION

The invention relates to a hydrogen tube trailer comprising a fuel cell for supplying electric loads and a method for controlling the gas flow of said tube trailer.

### BACKGROUND OF THE INVENTION

It is known in the art e.g. from the report titled: Safety of Mobile Hydrogen and Fuel Cell Technology Applications (dated October 2019 and drafted by Pacific Northwest National Laboratory) to have mobile systems comprising hydrogen source(s) supplying a fuel cell and thereby work as a mobile power supply for supplying electric loads. In this report it is also disclosed to have an electrolyser on a mobile system.

Further, it is known from US2005212281 to utilize hydrogen on a trailer to produce electricity. This electricity is used to supply the truck pulling the trailer and states that the electricity can be utilized for on board or off board load applications. Thus, occur in that art when using to onboard hydrogen to energy production for load applications in that this will reduce driving range of the truck pulling the trailer.

### SUMMARY OF THE INVENTION

The inventors have identified the above-mentioned problems and challenges related to ensuring enough hydrogen gas to use as fuel for a fuel cell vehicle and as supply for a fuel cell producing electricity to an electric load.

The present invention relates to a tube trailer for refueling a receiving vessel of a fuel cell vehicle and for supplying a fuel cell comprised by tube trailer for powering one or more electric loads. The present invention solves at least the problem of ensuring enough hydrogen to supply the fuel cell and thereby powering the electric load(s) without reducing the refueling capacity of the tube trailer.

Hence, in an aspect, the invention relates to a tube trailer comprising: a first hydrogen gas source comprising gaseous hydrogen, a second hydrogen gas source comprising gaseous hydrogen, a controller, an outlet connection, and a fuel cell. Wherein said first hydrogen gas source and said second hydrogen gas source, are fluidly connectable to said outlet connection and to said fuel cell via a conduit system, thereby facilitating refueling a receiving vessel, when connected to said outlet connection, and energy production by said fuel cell, and wherein said fuel cell is electrically connectable to an electric load thereby facilitating supply of electric power to said electric load, when electrically connected to said fuel cell. Wherein said controller is configured to establish a flow of said gaseous hydrogen in said conduit system from said first hydrogen gas sources to said fuel cell when the pressure in said first hydrogen gas source is below a dispensing threshold pressure.

Supplying a fuel cell comprised by a tube trailer from a hydrogen gas source comprising gaseous hydrogen below a dispensing threshold is advantageous in that it has the effect, that the efficiency of the use of the hydrogen gas stored in hydrogen gas sources of the tube trailer is increased. More specific, the amount of hydrogen gas remaining in the gas sources at the time of a trailer swap is reduced, hence energy used to bring hydrogen gas back to the trailer fill station or consolidate pressure in the gas sources is reduced or at best eliminated.

A further advantage is that the tube trailer becomes self-supplied with electric power without reducing refueling capacity i.e. without using hydrogen to produce electricity in the fuel cell that could have been used for refueling a fuel cell vehicle.

Yet a further advantage is that requirements to the site a self-supplied tube trailer of the present invention can be used as a mobile refueling station is reduced in that no onsite power plug is needed. Hence, additional flexibility in location of site is achieved and it becomes e.g. possible to locate a tube trailer at a pop-up event or temporary event.

Yet a further advantage is that hydrogen gas below a dispensing threshold pressure in a gas source can be exploited without the need of using energy on and a compressor to preform pressure consolidation between gas sources.

It should be noted that a reference to electric power or electric energy produced by the fuel cell both refers to the electric output from the fuel cell.

In an exemplary embodiment of the invention, said tube trailer is a mobile hydrogen refueling station.

In an exemplary embodiment of the invention, said tube trailer is a Multiple Elements Gas Container trailer having a plurality of individually controllable hydrogen gas source.

Individually controllable should be understood as a controller is able to control flow of gas to and from the gas sources by controlling valves in the individual conduit connecting the individual gas source to the rest of the conduit system.

In an exemplary embodiment of the invention, said tube trailer comprises a plurality of individually controllable gas sections.

A gas section should be understood as one or more gas sources defining a volume of the tube trailer that is able to store gaseous hydrogen. The size of a gas section may be change by including or excluding gas sources or other gas sections from the gas section. The change of volume of a gas section may be controlled by a controller controlling flow of gas to and from the gas sections by controlling valves in the individual conduit connecting the individual gas source/gas sections to the rest of the conduit system.

In an exemplary embodiment of the invention, said tube trailer comprises an energy storage.

An energy storage is advantageous in that it has the effect, that black start of the controller and other relevant electric components necessary to start up the fuel cell can be provided. The capacity of the energy storage depends on what it is intended to supply. Hence, if only start-up of the fuel cell is needed, the capacity of the energy storage does not need to be high (supply of controller, sensor, etc. prior to start of fuel cell). On the other hand, if a vehicle is to be charged from the battery, the capacity needs to be high.

In an exemplary embodiment of the invention, said energy storage is chargeable from said fuel cell.

Including an energy storage in the form of a battery/capacitor storage on the trailer is advantageous in that such energy storage may provide a power backup facility to the electric load if the fuel cell fails. Further, an energy storage may function as buffer storage i.e. the fuel cell can operate continuously and if not supplying a load it can charge the energy storage.

In an exemplary embodiment of the invention, said energy storage comprises a plurality of series connected battery modules.

Having a plurality of series connected energy storages is advantage in that the capacity of the energy storage increases and thus facilitates charging an electric vehicle requiring a charging capacity that increases the capacity of the fuel cell. During periods of low energy consumption (below capacity of the fuel cell) from electrical loads and where a gas source has a pressure below the threshold the fuel cell can be operated to charge the energy storage.

It should be mentioned, that if e.g. the controller give priority to charge an energy storage by the fuel cell, the fuel cell may be supplied from a gas source having a pressure above the dispensing threshold.

In an exemplary embodiment of the invention, a first end of a hose is connectable to said outlet connector and a second end of said hose is connectable to a receptable of a fuel cell vehicle.

Thereby a gaseous connection is established between the conduit system of the tube trailer and the receiving vessel of the fuel cell vehicle that is to be refueled. It should be noted, that several hoses can connect several receiving vessel and thereby facilitate simultaneous refueling of two or more fuel cell vehicles.

In an exemplary embodiment of the invention, said fuel cell is configured to produce electric power while said tube trailer is stationary and disconnected from a truck.

By truck should be understood the truck pulling the tube trailer. Only allowing the fuel cell to produce electric power while the tube trailer is stationary and disconnected from the truck is advantageous in that the truck can be used to other purposes as long as the fuel cell generates electric power.

In an exemplary embodiment of the invention, said tube trailer comprises a water supply.

In an exemplary embodiment of the invention, said tube trailer comprises an electrolyser.

Having a water supply (an onboard storage or an external supply) is advantageous in that then an onboard electrolyser may be supplied both with water and electricity (from the fuel cell). Thereby, the trailer is able to produce hydrogen and power allowing an increased in flexibility/variety of sites where it is profitable to locate a mobile refueling station in the form of a tube trailer according to the present invention.

In an exemplary embodiment of the invention, said conduit system is at least partly implemented as a manifold.

The is advantageous in that production time of the tube trailer conduit system is decreased and the risk of human errors in production is reduced.

In an exemplary embodiment of the invention, said conduit system comprises a pressure regulation valve (14) located upstream said fuel cell.

A pressure regulating valve is advantageous in that it has the effect, that the pressure and flow of hydrogen gas can be adapted to the specific requirements of the fuel cell. The controller may ensure an inlet pressure at the fuel cell complying with requirements of the particular fuel cell.

In an exemplary embodiment of the invention, said conduit system fluidly connects said first and second gas sources (2a, 2b) with said outlet connection and said fuel cell, wherein said fluid connections are individually controllable by valves.

This is advantageous in that it has the effect, that it gives the controller full flexibility of combining any gas source with any gas consumer (fuel cell, receiving vessel, etc.).

In an exemplary embodiment of the invention, said electric load is comprised by said tube trailer.

In an exemplary embodiment of the invention, said electric load is selected from the list comprising: said controller, light, a compressor, a cooling system, one or more sensors and one or more valves.

Supplying the controller with power from the fuel cell is advantageous in that the tube trailer becomes self-supplied i.e. can operate without being powered from a power supply external to said tube trailer.

Having a compressor on the tube trailer is advantageous in that it is then possible to perform pressure consolidation between gas sources and direct refueling from a gas source via the compressor. Having a cooling system is advantageous in that it refuelings can be made faster.

In an exemplary embodiment of the invention, said electric load is an electric vehicle charger.

Hence, the electric load may both be comprised by the trailer i.e. the generated electric power is consumed by a load located on the trailer or the electric load may be external to the trailer such as an electric motor of an electric vehicle. As an example external loads could include backup power supply systems, power supply for building lots or events such as concerts and exhibitions where permanent power supply with the required capacity is not available, electricity for off grid areas, etc.

In an exemplary embodiment of the invention, said tube trailer is configured to simultaneously refuel a receiving vessel of a fuel cell vehicle and charge a range extender battery of said fuel cell vehicle.

In an exemplary embodiment of the invention, said dispensing threshold pressure is 15 MPa, preferably 10 MPa, most preferably 5 MPa.

The dispensing threshold may change in dependency of type of vehicle that is to be filled from the tube trailer. Hence in case the vehicle is a bus or truck, the dispensing threshold pressure could be between 10 MPa and 0.2 MPa in that a bus or truck may have a pressure between 5 MPa and 10 MPa in its receiving vessel when connecting to the outlet conduit. In case the vehicle is a car, the dispensing threshold pressure could be between 15 MPa and 0.2 MPa in that a vehicle may have a pressure between 10 MPa and 15 MPa in its receiving vessel when connected to the outlet connection.

In an exemplary embodiment of the invention, said controller is configured to determine said dispensing threshold pressure based on pressure in said receiving vessel.

Such dynamic dispensing threshold pressure is advantageous in that it has the effect, that the used of hydrogen comprised by the storage vessels is optimal for refueling purposes. More specific when the refueling is made according to the cascade principles, and a receiving vessel has an initial pressure of 7.5 MPa. Then if the dispensing threshold pressure was 10 MPa, the fuel cell would be allowed to use hydrogen from a storage vessel having a pressure of 10 MPa i.e. at a pressure where the same hydrogen could also be used for refueling.

The dispensing threshold pressure may be determined as the pressure where a flow of gas between gas source having the lowest pressure (i.e. the first gas source used in a refueling made according to the cascade principles) and receiving vessel during a refueling according to the cascade principles is not sufficiently fast to satisfy the total time of a refueling of a receiving vessel of a fuel cell vehicle. A flow at which bank shift is expected or required is typically between 0.6 g/s and 10 g/s-20 g/s. It should be mentioned, that an upper gas low limit for a refueling may be 150 g/s due to protocols, temperature of the gas, design of the flow system and vessels, etc. Often at a flow in the above range (at the first gas source) the pressure in the gas source is below 10-20 MPa.

In an exemplary embodiment of the invention, said controller is furthermore configured to establish flow of said gaseous hydrogen in said conduit system from said second hydrogen gas source to said receiving vessel.

The conduit system may be designed to allow gas flow from any gas sources to any of the outlet connections and to the fuel cell. The gas flow is controlled by the controller controlling valves of the conduit system.

In an exemplary embodiment of the invention, said controller is furthermore configured to establish said flow of gaseous hydrogen to said receiving vessel simultaneously with said flow of gaseous hydrogen to said fuel cell.

Simultaneous flow is advantageous in that the power produced by the fuel cell based on a gas stream from a first of the gas sources can be used to control/facilitate a gas stream from a second of the gas sources to a receiving vessel connected to the tube trailer.

In an exemplary embodiment of the invention, said controller is furthermore configured to control said flow of gaseous hydrogen to said fuel cell from said first hydrogen storage vessel when the pressure in said first hydrogen storage vessel is above said dispensing threshold pressure.

Being able to supply the fuel cell from a gas source having a pressure above the dispensing threshold pressure is advantageous in that it has the effect, that in this way it is ensured, that the fuel cell can always be supplied with hydrogen gas and thus power supply to the electric load is secured.

The tube trailer according to any of the paragraphs 6-54 is controlled according to the method in any the paragraphs 56-99.

In an aspect, the invention relates to a method of controlling a gaseous flow in a conduit system of a tube trailer according to a refueling control strategy and a refueling and energy generating control strategy, wherein said conduit system is fluidly connected to a plurality of gas sources, an outlet connection and a fuel cell, and wherein said gaseous flow is a hydrogen gas flow controlled by a controller controlling status of a plurality of valves of said conduit system. Wherein, during said refueling control strategy, said controller is controlling a gaseous flow from a first gas source to a receiving vessel connected to said outlet connection until one of the following conditions are meet: the pressure of gas inside said first gas source reaches a dispensing threshold, or the gaseous flow from said first gas source to said receiving vessel reaches a determined flow speed. Wherein, during said refueling and energy generating control strategy, said controller is controlling a gaseous flow from said first gas source to said fuel cell. Wherein said controller change control strategy from said refueling control strategy to said refueling and energy generating control strategy when the pressure of gas inside said first gas source reaches a dispensing threshold pressure.

It is advantageous to supply the fuel cell from a gas source having a pressure that is below a dispensing pressure in that then hydrogen gas is used for its primary purpose namely refueling of receiving vessels of fuel cell vehicles. Then, when the pressure is below a dispensing limit instead for using energy on moving the tube trailer to a compressor or using an onboard compressor to pressure consolidation, energy can be generated via the fuel cell. All in all, this leads to a more efficient use of the hydrogen available on the tube trailer.

In an exemplary embodiment of the invention, during said refueling control strategy, said fuel cell is supplied with a flow of gaseous hydrogen from one of said plurality of gas sources during discontinuous periods of time.

Discontinuous periods of time should be understood as period of time where the fuel cell is supplied with gaseous hydrogen spaced in time with time periods where there is no supply of gaseous hydrogen to the fuel cell.

Only supplying the fuel cell discontinuously from a gas source having a pressure above the dispensing threshold pressure is advantageous in that the pressure of the gas source is only reduced as much needed maintaining as high pressure as possible in the gas source for future refuelings.

In an exemplary embodiment of the invention, said fuel cell is supplied from two different gas sources in two subsequent of said periods of time.

Changing gas source between two subsequent periods of time with flow to the fuel cell is advantageous in that the reduction of pressure in the individual gas source is reduce leading to more gas storages vessel with high pressure ready for refueling. With this said, according to a cascade control strategy, it may be desired to reduce pressure in one gas storage vessel at the time. Hence, the fuel cell may also be supplied from one and the same gas source in two subsequent periods of time.

In an exemplary embodiment of the invention, two subsequent refuelings, controlled according to said refueling control strategy, are both started with gaseous flow from said first gas source.

Two subsequent refuelings should be understood as the refueling of a receiving vessel of a fist fuel cell vehicle and subsequent a refueling of a receiving vessel of a second fuel cell vehicle.

This is advantageous in that it has the effect, that the pressure in the first gas source is reduced to the dispensing threshold pressure as fast as possible. Preferably, until the pressure in the first gas source is below the dispensing threshold pressure, the first gas source is used as source for refuelings.

In an exemplary embodiment of the invention, an electric load is supplied from an energy storage during said refueling control strategy.

Supplying an electric load from a battery is advantageous if no electric power is available from the fuel cell to avoid dependency of an external power supply for electric components.

In an exemplary embodiment of the invention, during said refueling and energy generating control strategy, said fuel cell is continuously supplied with a flow of gaseous hydrogen from said first gas source.

Continuously supplied should be understood as if an electric load requires a power supply, the fuel cell can deliver the required power because it has always access to hydrogen available the first gas source. Hence, continuously does not necessarily mean gaseous flow to the fuel cell, but rather that gaseous flow is continuously available to the fuel cell.

It should be noted that any of the plurality of gas sources having a pressure below the dispensing threshold pressure may be used to provide a continuous gas flow to the fuel cell.

In an exemplary embodiment of the invention, during said refueling and energy generating control strategy flow of gaseous hydrogen is established simultaneously to both said outlet connection and said fuel cell.

This is advantageous in that it has the effect, that electric energy can be produced by the fuel cell simultaneously with a refueling of a receiving vessel. Thereby, the electric energy required to perform a refueling can be provided from the onboard fuel cell.

In an exemplary embodiment of the invention, electric energy produced by said fuel cell is used to charge said energy storage.

This is advantageous in that it has the effect, that the charging of the energy storage can be done without reducing refueling capacity of the tube trailer.

In an exemplary embodiment of the invention, during said refueling and energy generating control strategy flow of gaseous hydrogen is established from a gas source having a pressure above said dispensing threshold pressure.

This is advantageous in that in this way a backup gas storage is available to the fuel cell and thereby the power supply to electric loads of the tube trailer in case all gas storages having a pressure below the dispensing threshold pressure runs dry.

In an exemplary embodiment of the invention, said electric load is supplied with electric power from said fuel cell

In an exemplary embodiment of the invention, said electric load is supplied with electric power from said energy storage.

In an exemplary embodiment of the invention, said dispensing threshold pressure and/or said determined flow speed is provided to said controller from a superior control system or is predetermined and stored in a data storage associated with said controller

The dispensing threshold pressure may be dynamic in the sense that depending on the amount on hydrogen available in the gas sources and the pressure thereof, the dispensing threshold may be changed. This change is determined by the controller based on the above-mentioned input including information about type of vehicle (i.e. if it is a bus/truck or a car). In the same way, the determined flow speed may depend on the available amount and pressure of gas in the gas sources. Hence, also the determined flow speed may be dynamic.

Further, if a forecast is available of future expected refuelings or timing of a future trailer swap is available this kind of information may also be used as basis for determining an appropriate level of flow speed and dispensing threshold pressure.

In an exemplary embodiment of the invention, said controller send a request to said superior control system that a trailer swap is required.

The superior control system should be understood as a control system external to the tube trailer such as a cloud-based computer, a hydrogen production and/or logistic controller, or similar. The superior control system may use information received from the trailer controller to plan hydrogen production, refill of trailer, trailer swap, etc. Communication between the controller of the tube trailer and the superior control system is preferably wireless.

When a predetermined number of the available gas sources reaches the dispensing threshold pressure (or the determined flow speed) it is an indication, that the trailer is soon to be empty for hydrogen gas. This information can be used to request a trailer swap.

It should be noted, that the controller may also send information of pressure, state of charge and the like to the superior control system and based on this information, the superior control system may determine when to swap a trailer.

In an exemplary embodiment of the invention, said determined flow speed is a flow speed of below 20 g/s, preferably below 10 g/s, most preferably below 0.6 g/s.

In an exemplary embodiment of the invention, said dispensing threshold pressure is dynamically determined by said controller based on a priority of one of an electric vehicle charging control strategy and a fuel cell vehicle refueling control strategy.

In an exemplary embodiment of the invention, said dispensing threshold pressure is above 50% of rated pressure of said storage vessel, preferably above 60% of rated pressure of said storage vessel, most preferably above 70% of rated pressure of said storage vessel, if said electric vehicle charging control strategy is chosen.

Rated pressure should in this context be understood as the maximum allowable pressure the storage vessels and thereby the hydrogen gas sources may contain during normal operation. In practise, the pressure in a storage vessel may be below rated pressure and thus a percentage of rated pressure should be understood as a percentage of the pressure of a storage vessel when the tube trailer arrives at its destination site.

The electric vehicle charging control strategy may be prioritized if only a few hydrogen refuelings are expected from the tube trailer before a future trailer swap. Hence, in this situation, the hydrogen comprised by the hydrogen gas sources of the tube trailer, may be best utilized as fuel for an onboard fuel cell producing electric power to a charger for an electric vehicle.

In an exemplary embodiment of the invention, said dispensing threshold pressure is below 50% of rated pressure of said storage vessel, preferably below 60% of rated pressure of said storage vessel, most preferably below 70% of rated pressure of said storage vessel, if said fuel cell vehicle refueling control strategy is chosen.

The fuel cell refueling control strategy may be prioritized if a high number of fuel cell vehicle are expected to be charged before a future trailer swap. Hence, in this situation, the hydrogen comprised by the hydrogen gas sources of the tube trailer, may be utilized best as fuel for a fuel cell vehicle.

In an exemplary embodiment of the invention, said controller control a first hydrogen gas source according to said electric vehicle charging control strategy and a plurality of additional hydrogen gas sources according to said fuel cell vehicle control strategy.

This is advantageous in that it has the effect, that the tube trailer in this way can be optimized to both charging electric vehicles and refuel fuel cell vehicles.

In an exemplary embodiment of the invention, said prioritizing of one of said electric vehicle charging control strategy and said fuel cell vehicle refueling control strategy is made based on a number of fuel cell vehicles simultaneously fluidly connected to said outlet connection.

If one or more fuel cell vehicles (receiving vessels thereof) are fluidly connected to the tube trailer, the fuel cell vehicle refueling control strategy may be prioritized thereby prioritizing the hydrogen comprised by the hydrogen gas storage to refueling.

In an exemplary embodiment of the invention, said prioritizing of one of said electric vehicle charging control strategy and said fuel cell vehicle refueling control strategy is made by a superior control system.

In an exemplary embodiment of the invention, said superior control system use a number of fuel cell vehicles associated with said tube trailer as basis for said prioritising.

The superior control system may allow a user of a fuel cell vehicle to register and associate the fuel cell vehicle with the tube trailer. The registration may include expected refueling needs such as number of expected weekly refuelings.

A method according to any of the paragraphs 56-99 implemented in an apparatus according to any the paragraphs 6-54.

### THE DRAWINGS

For a more complete understanding of this disclosure, reference is now made to the following brief description, taken in connection with the accompanying drawings and detailed description, wherein like reference numerals represent like parts. The drawings illustrate embodiment of the invention and elements of different drawings can be combined within the scope of the invention:

FIG. 1 illustrates a tube trailer 1 with a fuel cell,

FIG. 2 illustrates two storage vessels, and

FIG. 3 illustrates a tube trailer with a fuel cell and an electric vehicle charger.

### DETAILED DESCRIPTION

The present invention is described in view of exemplary embodiments only intended to illustrate the principles of the present invention. The skilled person will be able to provide several embodiments within the scope of the claims.

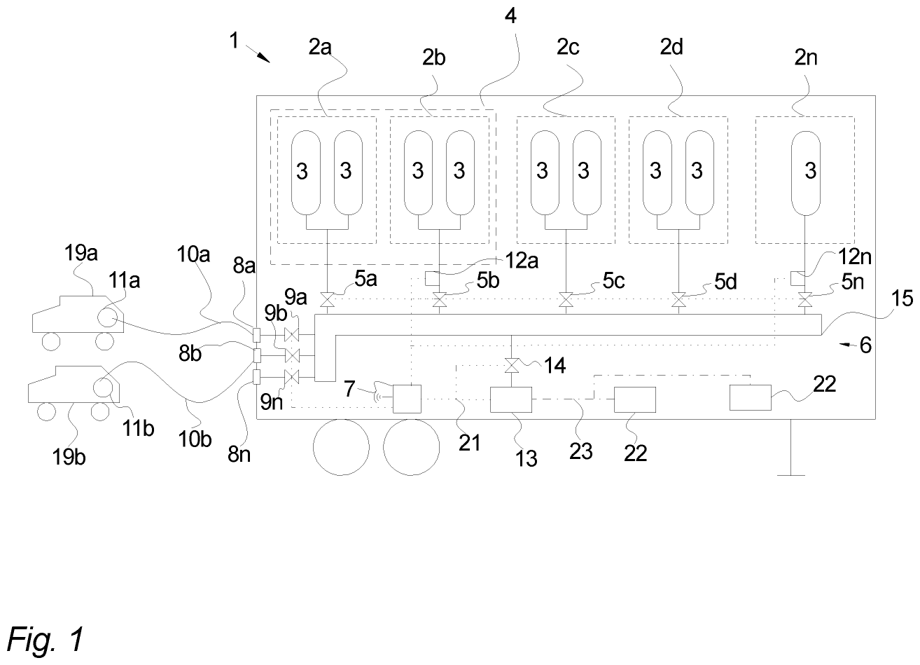

FIG. 1 illustrates a mobile hydrogen refueling station in the form of a tube trailer 1 according to an embodiment of the invention. The mobile hydrogen refueling station 1 (sometimes referred to simply as mobile station or tube trailer) comprises first, second, third, fourth and fifth hydrogen gas sources 2a-2n (sometimes referred to simply as gas source and commonly denoted 2) each comprising one or more hydrogen storage vessels 3 (sometimes referred to simply as storage vessel).

The first and second hydrogen gas source 2a, 2b is in FIG. 1 illustrated as joined forming a gas section 4. Hence, the volume available for storing gas in section 4 is the volume of the storage vessels 3 of first and second gas sources 2a, 2b. Each of the storage vessels 3 and thereby the gas sources 2 are connected to a conduit system 6 via gas source valves 5 enabling control of flow from each individual gas source 2 to the conduit system 6. Together, the gas sources 2, storage vessels 3 and gas sections 4 may be referred to as gas storage.

Accordingly, when the mobile refueling station arrives at a refueling site, preferably each of the storage vessels 3 and thereby the gas sources 2 are filled to a start pressure between 35 MPa and 100 MPa such as e.g. a pressure of 50, 60, 70, 80 or 90 MPa. A first refueling may only require gas from the first, second and e.g. third gas sources 2a-2c and thus because of the gas source valves 5 the pressure in the fourth and fifth gas sources 2d, 2n remain at the start pressure.

In an embodiment of the invention, the volume of the gas sources 2 can be changed by controlling status of one or more gas section valves (not illustrated). Hence, if a gas section valve is open between two gas sources 2 the volume of these may be considered as one.

It should be mentioned that the mobile refueling station 1 illustrated on FIG. 1 is only an example of a mobile refueling station according to the invention. Thus, more or less valves, storages, sources, etc. may be required for a specific implementation of the present invention. Typically, the number of vessels, sections and banks is a customer/designer choice based on the application in which the mobile refueling station 1 is to be used and thus any combination of the illustrated elements that is physically and legally allowed to locate on a mobile refueling station is possible.

The mobile refueling station is not restricted to use any particular type of gas vessel 3, and a person skilled in the art may select any type of gas vessels 3, suitable for realizing the invention as long as they comply with requirements to at least gas and pressure they are to store. Particularly, gas vessels should be able to withstand and approved to be used for transportation of gaseous fluid pressures up to, for example, 50 MPa, but gas vessels according to the invention are not restricted to this example of maximum pressure. Gas vessel 3 used in the gas sources 2 could in principle be any type as longs as they comply with local requirements to transport and storage of gaseous fluids in particular hydrogen gas.

The number of gas vessels 3 defining the volume of a gas source 2 can be 1 or more up to e.g. 15 individual gas vessels 3.

The mobile refueling station 1 comprises a conduit system 6, which fluidly connects the gas sources 2 to outlet connections 8. On FIG. 1 a first, second and third outlet connection 8a-8c is illustrated. Flow of hydrogen gas to the outlet connections 8a-8n can be controlled by outlet valves 9a-9c.

In an embodiment, outlet valve 9 may control flow to more than one outlet connection 8 and thereby to more than one receiving vessel. This is illustrated on FIG. 1 by outlet valve 9c which is connected to outlet connection 8c and the dashed outlet connection 8n. Note that all of the outlet valves 9 may be connected to one more outlet connections.

At least when e.g. two receiving vessels are having the same gas pressure this is advantages or when a paused refueling method is implemented. Then, when two refuelings are made simultaneous but only with flow to one receiving vessel at the time the same outlet valve 9 can be used for two simultaneous refuelings. The outlet valve 9 may in this and other embodiments be referred to as a gas flow regulation valve regulating gas flow to receiving vessels.

The mobile refueling station 1 may be built up of on a truck trailer chassis carrying storage vessels 3 e.g. in the form of tubes that as mentioned can store hydrogen gas at controlled pressure. Alternatively, the mobile refueling station 1 is skid mounted and thereby possible to lift from one location to another. if the mobile refueling station is built on skids, typically one or more hydrogen gas sources skids and a valve/control skid would be required.

Independent of the type of implementation of the mobile refueling station it may comprise a cooling system and still perform refuelings according to the methods described in this document.

The valves used to control flow of hydrogen gas may be any suitable type of valves such as block and bleed valves, air-operated valves, solenoid valves, directional control valves, gate valves, etc. Air-operated valves can for example be operated using an internal or external pressure source part of or connected to the mobile refueling station. Such a pressure source can for example be a compressor at a hydrogen refueling station. Alternatively, air-operated valves can be operated using an internal pressure source, for example from a compressed air brake system. Solenoid valves can for example be powered by a battery or fuel cell located on the trailer. Power to power consumers on the mobile refueling station may also be provided by cables from external fuel cell, battery, electric socket, or similar power supply.

Generally, embodiments of the invention are not restricted to any particular types of valves, and a person skilled in the art may select any valves, suitable for realizing the invention. In one embodiment, the valves are simple one way-valves (on/off valves) that allows or stops flow in a conduit of the conduit system 6. Depending on the configuration of the vales, pressure in vessels, etc. these one-way valves may allow a gas to flow in a first direction when a valve is first opened. When closed and subsequently opened again, the pressure in gas sources 2 may have changed so that now gas flow in the opposite direction. In this way flow direction can be changed by control of the valves and thus dynamic two-way flow in the conduit system can be established.

More specifically, the two-way flow in the conduit system is facilitated by controlling valves so that in one conduit/path flow is in the first direction and in another conduit/path flow is in the opposite direction. Direction may here be defined with respect to outlet, vessel, etc. One-way valves are advantageous in that the simplifies the design of the conduit system 6 compared to the use of multi-way valves or valves panels that required a higher number of conduits close together around such multi-way valve. In the present invention, being able to distribute one-way vales as desired between vessels/sections/sources is advantage in that it increases the flexibility in design of the mobile refueling station.

The valves of the mobile refueling station are distributed such that by control of the status of the source valves 5, section valves (if present), outlet valves 9 and individual storage vessel valves (if any), allow control of flow of gas from the storage vessels 3 to the outlet connections 8 and vice versa can be controlled.

More specifically, this means that the pressure in the gas sources can be controlled based on the relatively random gas equilibrium between a receiving vessel and a source vessel during a cascade refueling. The gas equilibrium is typically reached when the pressure different between source and receiver is below 5 MPa. The lower pressure difference, the slower flow.

According to the present invention, the shift from one gas source 2 to another gas source 2 during a cascade refueling can be made at controlled gas pressure. Taking into consideration the pressure of all hydrogen gas sources 2 it can be determined to shift gas source even if equilibrium is not obtained between a gas source and a receiving vessel.

Alternatively, or in addition, the shift of gas source may also be controlled based on a desired flow rate also referred to as desired flow speed. If e.g. the gas in the receiving vessel is getting close to the maximum temperature threshold, the flow could be continued but with a reduced flow rate to postpone or avoid reaching the maximum temperature threshold.

Further, it should be mentioned that it e.g. based on temperature development in gas in the receiving vessel, it can be determined to pause the refueling from one gas source without changing gas source when resuming the refueling.

Flow is typically regulated to ensure that an upper flow limit (sometimes specified in a refueling standard) is not crossed.

When referring to a gaseous flow, a reference to transfer of gas from a gas source to e.g. receiving vessel over time. Gas flow below 0.001 kg per second is considered a pause or stop of flows. A normal flow is considered between 0.02 kg per second and 0.2 kg per second such as around 0.12 kg per second, hence a low flow can be below 0.02 kg per second and a high flow is e.g. above 0.2 kg per second up to e.g. 0.4 kg per second. Change of gas source may be considered when the gas flow is reduced to e.g. 0.01 kg per second. The mentioned limits are examples and may obviously change e.g. according to design of mobile refueling station, types of fuel cell vehicles that is to be refueled, etc.

As mentioned, the flow of gas in the conduit system towards a receiving vessel can be controlled e.g. based on temperature of gas in the receiving vessel and based on pressure in the storage vessels 3. Information of pressure in the storage vessels 3 may be obtained by sensor units 12. In the embodiment illustrated in FIG. 1, a sensor unit 12 is associated with gas source 2b, 2n such that it may record a physical state of the pressurized gaseous hydrogen contained in gas vessels 3 thereof. Depending on status of valves, this sensor unit may also measure physical state of pressurized gaseous hydrogen in other storage vessels 3.

The physical state that the sensor units 10 record may for example be pressure and/or temperature. Note that embodiments of the invention are not restricted to two sensor units, and may for example comprise one, three, four, five, or more than five sensor units, for example distributed in the conduit system, associated with any of the gas sources/storage vessels, etc. A sensor unit may typically either measure a single or multiple properties, including a physical state, of a pressurized gaseous fluid for each vessel, section and/or bank of a mobile refueling station 1.

It should be mentioned that the measurements from a sensor unit may vary depending on flow in the conduit system 6. Accordingly, if e.g. pressure is measured as sections valves are open, allowing gaseous fluid to move from one section to another (pressure equalization), the measured pressure may settle after a settling period. This is because the flow affects pressure measurements and performing a measurement which is indicative of an equilibrium pressure may require waiting a settling time measured in seconds such as below 30 seconds after flow has ended. Similarly, when section valves are opened and flow begins, the temperature may increase with pressure. Hence, a temperature measurement may also require a settling time to pass.

Pressure measurements in general are made on gas vessels of the mobile refueling station partly for safety reasons such as for leakage detection and partly for optimized control of refueling of a fuel cell vehicle from the mobile hydrogen refueling station 1. Hence, when the mobile refueling station 1 knows pressure both at the storage and at the nozzle the pressure reduction in the mobile refueling station can be determined and controlling of refueling can be adapted accordingly.

In the embodiment of FIG. 1, the sensor units 12a-12b are communicatively connected to a monitoring and control unit 7 (also referred to simply as controller), which receives representations of the physical states i.e. the measurements that the sensor units 12a-12b record, to generate trailer information data, which is stored on a data memory. This data memory may, for example, be physically connected to the monitoring unit and control unit and thus located on the mobile refueling station (tube trailer 1), or it may, for example, be a cloud-based data memory, with which the monitoring and control unit 7 communicates wirelessly. The exact specifications of the monitoring and control unit 7 may be chosen accordingly by a skilled person.

The data communication between the controller 7 and the valves 5, 9, 14 and other parts of the control system is indicated by dotted lines 21 even though the communication may also be implemented as wireless communication.

The controller may be implemented as a standard industrial controller such as a programmable logic controller (PLC). In embodiments a dedicated safety controller (not illustrated) may also be implemented as part of a safety control system of the tube trailer 1.

Further, FIG. 1 illustrates a mobile refuelings station (also referred to as tube trailer 1) to which two receiving vessels 11a, 11b of fuel cell vehicles 19a, 19b are connected via fill hoses 10a, 10b. The flow of gaseous hydrogen from the storage vessels 3 to the receiving vessels 11 can be controlled by the controller 7 controlling valves of the mobile refueling station.

The receiving vessels 11 is preferably part of a fuel cell vehicle 19a, 19b but could also be part of another mobile refuelings station or a stationary hydrogen refuelings station.

The conduits connecting gas source and outlet connections may comprise a number of individual conduits. Alternative, the number of individual conduits is reduced by implementing a manifold 15 thereby simplifying the mobile refueling station 1 design by replacing valves and conduits with a single manifold 15.

The flow from a gas source is controlled by the gas source valve 5 and to the receiving vessel by the outlet valve 9. It should be mentioned, that independent of implementation of the conduit system 6 (as a plurality of conduits and valves or as a manifold) redundancy of gas source valves 5 and outlet valves 9 are preferred at least for safety reasons. Redundancy should be understood as two or more valves connected in series.

The controller 7 may facilitate estimation/calculation of which gas source to connect to the receiving vessel based on information including information of pressure in the receiving vessel and in all of the gas sources 2. In this way the controller 7 is able to select a gas source that has a pressure above the receiving vessel. Further the selection of gas source may also be made to match a desired pressure profile of pressure in all of the gas sources.

A pressure profile should be understood as a number of desired pressure levels distributed between the gas sources/gas sections of the mobile refueling station. A pressure profile may be established based on knowledge of refueling frequency/pattern of a given site. Such refueling pattern would include information of typical start pressure, refueling time, information of various relevant temperatures, etc.

In an embodiment of the invention where the sources are holding pressures of 25, 30, 45, and 50 MPa where the start pressure of the receiving vehicle is 19 MPa, such a pressure profile might be depending on the preferences between utilization degree of the gas available in the gas sources and the speed of refueling. In this case the 25 MPa storage would be used as the initial pressure source if hydrogen utilization was the main objective, whereas the 30 MPa storage might be chosen if refueling speed is more important.

Selecting the match of gas source and receiving vessel alone on or on a combination of small pressure different and small remaining volume is advantageous in that the gas sources are empties as much as possible and thereby the efficiency of the mobile refueling station is increased e.g. in terms of power used to reload the mobile refueling station, energy used on returning the mobile refueling station to its reload site with remaining hydrogen gas, etc.

As illustrated on FIG. 1, the tube trailer 1 also disclose a fuel cell 13 that is supplied with hydrogen from the conduit system 6, in this example from a manifold 15. The flow of gaseous hydrogen to the fuel cell 13 is controlled by the controller 7 via a regulating valve 14. Accordingly, the amount of electric power produced by fuel cell 13 is at least indirectly controlled by the allowed flow of the gaseous hydrogen to the fuel cell 13. It should be mentioned that the control may include the flow of gaseous hydrogen and the fuel cell 13 i.e. the start-up and operation of the fuel cell. In addition, the control may also include a safety system monitoring and controlling the gaseous flow and fuel cell to avoid hazardous situations.

The electric power produced by the fuel cell 13 is distributed to one or more electric loads 22 of the tube trailer 1 via power supply lines 23. The electric loads may include the control system i.e. the controller 7 and the associated valves and sensors which may be power directly from the fuel cell 13 (not illustrated) or via the communication lines 21.

The capacity of the fuel cell 13 may be selected according to the expected consumption of the electric loads(s). Hence, if only the control system is to be supplied the capacity of the fuel cell 13 can be less than if also a charger 17 should be supplied. Hence, the fuel cell 13 can be selected according to required capacity. If the fuel cell is only to supply the controller 7 and minor onboard electric loads such as valves and sensors, a sufficient capacity of the fuel cell is in the range of 2-10 kW. If the fuel cell is to supply offboard loads such as charger for electric vehicles, onboard compressor and cooling systems, the capacity of the fuel cell may be in the range of 100-300 kW. Further, if the operation range of a relevant fuel cell is e.g. between 0° C. and 100° C. and with an operation pressure starting from 0.1 to 0.3 MPa, a heating element may also be included and supplied from the fuel cell or a battery. If the fuel cell is to be started at an ambient temperature below the operation range such as minus 20° C., the heating element may be supplied from the battery until the temperature is within the operation range. Thus, if a gas source 2 supplying the fuel cell 13 has a pressure higher than the rated inlet pressure of the fuel cell, the controller 7 is, via the regulating valve 14, reducing the pressure to comply with the allowable inlet pressure of the fuel cell 13.

Preferably, the controller 7 control the flow of hydrogen from the storage vessels 3 to the receiving vessel 11 and fuel cell 13 so that it is ensured that hydrogen is available for keeping the controller 7 alive. Hence, even though hydrogen could be used to charge an energy storage or an electric vehicle, this is not prioritized if there is a risk that by doing so, there is not hydrogen left to supply the controller.

With this said, in the event, that the tube trailer comprises an energy storage capable of supplying the controller and that energy storage holds sufficient capacity, hydrogen can be used e.g. to charge the energy storage and thereby ensure power to the controller.

The fuel cell 13 and/or the controller 7 may be connected to a battery powering the fuel cell/controller during start-up. Thereby, black start of the tube trailer is enabled. The battery may subsequently be charged by the fuel cell.

An alternative method of black start of the tube trailer 1 is by connecting an electric vehicle 18 to the charger 17 and thereby indirectly to the fuel cell 13 which then can be powered during start up from the battery of the electric vehicle 18.

It should be noted that the tube trailer 1 may comprise more than one individual controllable fuel cell 13. By fuel cell should be understood the components needed to start, operate and shut down the fuel cell. Such components may include battery, inverter, pressure regulation means such as valves, sensors, controller, filter, heater, etc. In case two fuel cells are implemented on the tube trailer some of these components may be used by both fuel cells.

The electric loads 22 may as mentioned include the controller 7 and also an electric vehicle charger 17. Further, if relevant, the electric loads 22 may also include light, cooling system, compressor, energy storage, etc. It should be noted electric loads external to the tube trailer 1 (not illustrated) could also be supplied.

The electric vehicle charger 17 (also simply referred to as charger) may be connectable to an electric vehicle 18 which then can be charged with electric power produced by the fuel cell 13 comprised by the tube trailer 1.

As mentioned, one of the electric loads 22 may be an energy storage 20. An energy storage 20 may be built of a string of series connected energy modules in the form of battery modules and/or capacitor modules. A battery module may comprise a plurality of series connected battery cells. An energy storage controller may control connectivity of the battery modules to each other thereby forming the battery string by controlling a switching arrangement associated with each individual energy module.

In an embodiment, the switching arrangement comprises semiconductor switches such as IGBTs in an H-bridge configuration. In this embodiment, the charging and discharging of the energy modules may be controlled in size and type. Size should be understood as at least a charging voltage equal to one energy module voltage can be used and type as the battery string may be controlled to supply an AC or a DC electric load.

It should be mentioned that the fuel cell 13 may charge the energy storage and then the electric loads may be connected to and supplied by the energy storage. This may also include the energy storage controller. The larger capacity of the energy storage the more electric loads can be supplied. One example of an energy storage capacity is between 5 kWh and 10 kWh. An example of a high capacity energy storage 20 could be a capacity between 100 kWh and 200 kWh. With respect to charging electric vehicles, such high-capacity energy storage may be used to charge electric busses or trucks whereas less capacity energy storages may be used only top up charging of electric vehicles.

In the embodiment, where the tube trailer 1 comprises a charger 17, a fuel cell vehicle 19 having a battery-based range extender can both be refueled and recharged simultaneously.

A tube trailer 1 according to the present invention comprising a charger 17 is especially advantageous at sites where the need for refueling fuel cell vehicles and charging of electric vehicles are changing. An example hereof is road construction where the construction vehicles move as the road is constructed. At such site, a tube trailer according to the present invention is especially advantageous.

In a particular embodiment, the site at which the tube trailer 1 is located, the comprises a power plug connected to the utility grid via which electric loads of the tube trailer 1 can be supplied. In this embodiment, the tube trailer 1, comprising an electric vehicle charger 17 and a fuel cell 13, may have an adaptor function where the charger 17 is supplied at least partly from the utility grid plug. In this way, the site does not have to change to or install an electric vehicle charger 17 since electric vehicle 18 can be charged via the tube trailer 1.

As mentioned, the dispensing threshold pressure is used to differentiate between when it is preferred that a fuel cell 13 is supplied from a particular storage vessel and when the hydrogen of that storage vessel is used to refuel a receiving vessel 11.

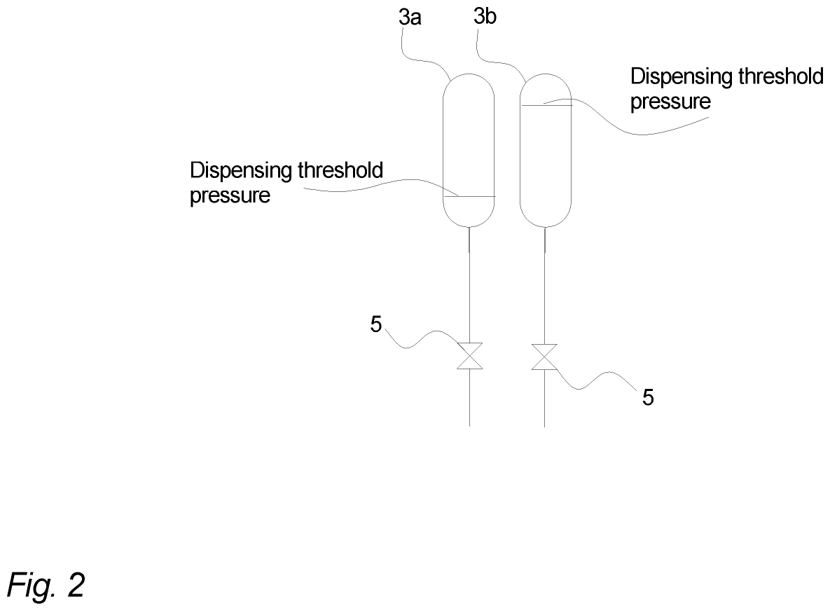

FIG. 2. illustrates two storage vessels 3a, 3b each having a dispensing threshold pressure. In the storage vessel 3a, the dispensing threshold pressure is at a relatively low SoC. Hence, this storage vessel 3a is suitable for use as supply for the fuel cell 13 and in this way empty (as much as possible) the storage vessel 3a by supplying the fuel cell 13 and thereby produce electricity. This is especially true if the pressure in the storage vessel 3a is equal to or below the pressure in a receiving vessel connected to the tube trailer 1 for being refueled in that the hydrogen of this storage vessel cannot be used to fill the receiving vessel via the cascade fill principles.

The storage vessel 3b, has a dispensing threshold pressure at a relatively high SoC. Hence, this storage vessel 3b is suitable for use as supply to a receiving vessel 11. This is especially true if the pressure in the storage vessel 3a is above the pressure of a receiving vessel connected to the tube trailer 1 for being refueled.

It should be noted that the SoC is calculated based on information of pressure and temperature (and volume) of the storage in question. Pressure, temperature, mass flow, etc. is referred to as operation parameters having values e.g. describing pressure and temperature of the hydrogen in the storage in question. These values may be established by or monitored and subsequently received by the controller 7 from sensors 12 of the vehicle and/or tube trailer. Such sensors may be positioned inside or at a storage vessel, inside or at a conduit, etc.

Accordingly, if information is available of temperature in a storage vessel, then based on a measurement of pressure and knowledge of the volume of the storage vessel SoC of that storage vessel can be calculated and thus, SoC may be used as the dispensing threshold pressure.

As an alternative, the dispensing threshold pressure is closely related to or indirectly a measure for mass flow between a storage vessel 3 and a receiving vessel 11. This is at least true when the pressure in the receiving vessel increases and closes up to the pressure in the storage vessel where pressure is decreasing. Hence when the pressure difference between these two pressures is less than 15 MPa, 12.5 MPa or 10 MPa, the mass flow may reach a mass flow value that can be used instead of the dispensing threshold pressure. Hence, if the mass flow reaches a certain value such as between 6 g/s and 10-20 g/s in the conduit between one storage vessel 3 and a receiving vessel 11, the dispensing threshold pressure could be considered to be reached.

It should be mentioned that a relatively low mass flow may be measured also if the SoC/pressure of the source storage vessel is relatively high. This is the case if a receiving vessel is only to be topped up by flow from the storage vessel. Then the pressure difference between the two may not be significant enough to establish high mass flow. Accordingly, even though possible, mass flow is therefore not always considered the best to use as threshold value substituting the dispensing threshold pressure.

With respect to pressure, as example, a relatively high dispensing threshold pressure is e.g. 40 MPa if the start pressure of the storage vessel 3 is 50 MPa and a relatively low dispensing threshold pressure is e.g. 10 MPa or below if the start pressure of the storage vessel 3 is 50 MPa. 50 MPa storage is sufficient to use for a 35 MPa refueling of e.g. a heavy-duty vehicle whereas 90 MPa or more is sufficient to use for a 750 bar refueling of e.g. a light duty-vehicle.

The SoC, pressure, mass flow of/from the plurality of storage vessels 3 may be controlled so as to ensure optimal pressure in each of the storage vessels to perform cascade refuelings from the tube trailer. This control strategy is referred to as refueling control strategy and is optimized to ensure best possible to have storage vessels with appropriate pressures that is ready to perform cascade refueling of a connected receiving vessel.

The refueling control strategy control bank shift during a cascade fueling so as to ensure the highest pressure in the storage vessels as possible. Hence, the refueling control strategy include to have a relatively low dispensing threshold pressure.

Alternatively, the SoC, pressure, mass flow of/from the plurality of storage vessels 3 may be controlled so as to ensure flow of hydrogen to the fuel cell 13. This control strategy is referred to as the energy generating control strategy and include ensuring that the fuel cell 13 always have access to hydrogen from a storage vessel 3.

Hence, the energy generating control strategy include to have a relatively high dispensing threshold pressure. One reason why it should be considered not to use hydrogen from a 50 MPa storage vessel comprising hydrogen at a pressure of 50 MPa is that hydrogen at this pressure would be beneficial to use as the last step in a cascade refueling of a 35 MPa fuel cell vehicle (i.e. a heavy duty vehicle)

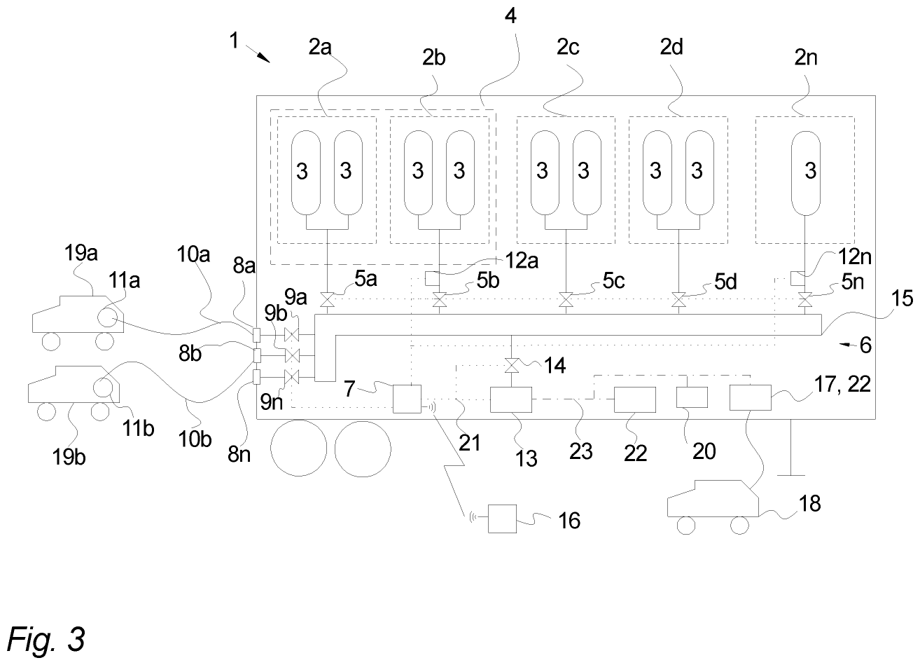

When the tube trailer 1 comprises an electric load 22 in the form of a charger 17 for an electrical vehicle 18, hydrogen flow is controlled according to a special case of the energy generating control strategy referred to as an electric vehicle charging control strategy. This embodiment is illustrated in FIG. 3.

It should be noted that a fuel cell vehicle 19 may be connected to both the charger 17 and outlet connection 8 and thus both be charged/refueled at the same time. This may be relevant if the fuel cell vehicle comprises a battery range extender.

On the embodiment illustrated on FIG. 3, the tube trailer 1 comprise a charger 17 for an electric vehicle 18. The charger 17 may be electrically connected to an energy storage 20, the fuel cell 13 or both. Thereby it becomes possible to both refueling of a fuel cell vehicle 19 and charging of an electric vehicle 18. Such an embodiment of the tube trailer 1 of the present invention, is advantageous in that in areas where the number of fuel cell vehicles 19 are limited, the hydrogen gas may also be utilised for charging electric vehicle 18. Thereby the tube trailer 1 helps to develop both the charging and the hydrogen refueling infra structure.

To ensure the correct balance between using the hydrogen comprised by the tube trailer as fuel for a fuel cell vehicle and as fuel for an onboard fuel cell, the controller may prioritize between two control strategies. One with focus on refueling and one with focus on charging. Typically, the default control strategy would be the refueling control strategy.

The decision of the controller to prioritize one of these control strategies may be based on past history of hydrogen consumption as fuel for refueling. Hence, in one extreme if no refuelings are made during the past two weeks, then it may indicate that the location of the tube trailer is wrong. Therefore, until it is relocated, hydrogen comprised by the tube trailer, may instead be used as fuel for the onboard fuel cell 13.

The onboard fuel cell 13 may supply an energy storage (e.g. located onboard) which again may supply an electric vehicle charger 17 (e.g. located onboard) connected to the energy storage or it may supply the electric vehicle charger 17 directly.

Past refueling and/or vehicle charging may also be used as basis for the controller to take decision on how to prioritize the use of hydrogen of the tube trailer.

Further, the user of a fuel cell vehicle 19 or an electric vehicle 18, may communicate directly with the controller to see the available capacity i.e. to what extent (time for refueling/charging, possible SoC, etc.) a refueling or an electric charging is possible. If the user of an electric vehicle 18 decides to drive to the tube trailer 1 to charge, the controller 7 is informed and may switch to the charging control strategy and e.g. start charging an onboard energy storage.

A tube trailer according to the present invention is advantageous in that it may assist supplying power to electric loads on site of location of the tube trailer. It may be so, that the entire power supply may be provided by a tube trailer. Hence, if the site comprises more than one tube trailer according to the present invention, one may be controlled according to a power supply control strategy and another according to a refueling control strategy. Hence, a completely full tube trailer may start being controlled according to a refueling control strategy and as the hydrogen reaches the dispensing threshold, the control strategy may change to energy generating control strategy. During this dynamic change of control strategies, the tube trailer may be controlled according to a hybrid between a refueling and power generating control strategies. A superior control system may be used to coordinate the trailer swap, which control strategies should be used on which tube trailer, etc.

Alternatively, data related to a number of fuel cell (and/or electric) vehicles associated with the tube trailer 1 may be used to forecast the need for hydrogen gas used as fuel for fuel cell vehicles 19. An owner of a fuel cell vehicle may associate his/her fuel cell vehicle digitally with the tube trailer e.g. directly via the controller or via a superior control system 16 communicating with the controller 7.

A superior control system 16 would typically be implemented as a cloud based computer system communicating with a fleet of tube trailers, trailer fill stations, hydrogen production system(s), service and operation systems, logistics systems etc. I.e. a superior control system should be understood as a computer system managing production and logistics related to hydrogen.

If the hydrogen comprised by the tube trailer is prioritized to be used as fuel for hydrogen refueling vehicles, the dispensing threshold pressure is reduced so as to ensure as much hydrogen as possible for this purpose. Hence, the dispensing threshold pressure for a hydrogen gas storage having a pressure of 100 MPa at 100% SoC may e.g. be reduced to a pressure in the range of 5 MPa-50 MPa such as 10 MPa-40 MPa such as 20 MPa. In this way, it is ensured, that hydrogen is available for refueling the receiving vessel and thus the fuel cell 13 can be supplied with hydrogen gas below the dispensing threshold pressure.)

In the same way if hydrogen comprised by the tube trailer is prioritized to be used as fuel for charging electric vehicles, the dispensing threshold pressure is increased so as to reserve hydrogen for this purpose. Hence, the dispensing threshold pressure for a hydrogen gas storage having a pressure of 100 MPa at 100% SoC may e.g. be increased to a pressure in the range of 50 MPa-90 MPa, such as 60 MPa-80 MPa such as 25 MPa. In this way, it is ensured, that the fuel cell does not used hydrogen comprised by a hydrogen gas source e.g. on refueling unless the pressure of hydrogen in that hydrogen gas source is above the dispensing threshold pressure.

It should be mentioned that the controller 7 may apply the control strategies to only one hydrogen gas source 2. Thus, on a tube trailer 1 having four individual controllable hydrogen gas sources 2, only one of these may be dedicated to e.g. supply the fuel cell for providing electric power to an electric vehicle charger and thus, be controlled according to the charging control strategy. The remaining three hydrogen gas sources 2 may be controlled according to the refueling control strategy.

It should be noted that it may be important for the operation of the tube trailer 1 to ensure supply of the fuel cell 13 for powering the control system of the tube trailer 1. By control system should be understood controller, valve and sensor, but could also include light, compressor, cooling system, etc.

As mentioned, the controller 7 may communicate with a superior control system 16 to receive information e.g. of which control strategy to implement on which number of storage vessels 3/hydrogen gas sources 2.

The controller 7 may also provide information of e.g. SoC of the storage vessels 3/hydrogen gas sources 2 i.e. the remaining capacity of the tube trailer 1 to the superior control system 16. Based on this information, the superior control system 16 may plan trailer swap.

The superior control system 16 may facilitate registration of vehicle (electric/fuel cell) and associate the vehicle with information related to drive pattern, customer (vehicle) type (35 MPa or 75 MPa), ambient temperature, vehicle battery/hydrogen state of charge, location etc. This information may obviously be anonymised. This information may be used to determine control strategy for one or more tube trailer of a fleet of tube trailers, expected time of trailer swap, choice of energy production and refueling control strategy i.e. refuel or supply power, ensure/balance availability of hydrogen or electricity, etc.

The superior control system 16 may be implemented as a cloud server/service communicating with controllers of a plurality of tube trailers, electric vehicles, fuel cell vehicles and controllers associated with or controlling other aspects/services of a hydrogen infrastructure. Such services may include logistics, hydrogen production, service and maintenance, etc.

From the above it is now clear that the invention relates to a tube trailer 1 and a method of controlling the tube trailer 1 so as to ensure hydrogen capacity for refueling fuel cell vehicles. Further, an aspect is to ensure hydrogen capacity for charging an electric vehicle.

The tube trailer 1 comprise a plurality of individual controllable hydrogen gas sources 2 and a controller for controlling flow of gaseous (or liquid if relevant) hydrogen from the gas sources 2 to the outlet connections 8 and further to receiving vessels 11 of fuel cell vehicles 19. In addition, the tube trailer 1 comprises a fuel cell 13 that is supplied from the gas sources 2 and may produce electric power to supply the control (system) 7 of the tube trailer 1.

In addition, the tube trailer 1 may comprise a charger 17 for charging an electric vehicle 18. The charger 17 is also supplied from the fuel cell 13 and thus hydrogen from the gas sources 2 may, via the fuel cell 13, be used as source for charging an electric vehicle. In the embodiment, where the tube trailer 1 also comprises an energy storage 20, this may also be charged from the fuel cell 13.

In addition, the controller may communicate bidirectionally with a superior control system to receive setpoints for operation parameters, control strategies, etc. Further, the controller 7 may communicate values of operation parameters to the superior control system 16 which then can be used to control upstream parts of the hydrogen infrastructure.

Especially, when relying on a hydrogen gas source of a tube trailer 1, comprises hydrogen gas having a pressure below a dispensing threshold, as supply to the fuel cell 13 and thereby the power supply to the electric load is risky in that a risk of running out of gas and thereby loose power to the fuel cell is real. Thus, the present invention relates to a tube trailer 1 and a method of controlling the gas pressure in gas sources thereof so as to ensure that as long as there is gas to be refueled, there is also enough gas to supply the fuel cell 13 and thereby supply electric loads from the fuel cell 13.

The invention has been exemplified above with the purpose of illustration rather than limitation with reference to specific examples of methods and robot systems. Details such as a specific method and system structures have been provided in order to understand embodiments of the invention. Note that detailed descriptions of well-known systems, devices, circuits, and methods have been omitted so as to not obscure the description of the invention with unnecessary details.

### LIST

1. Tube trailer

2. Hydrogen gas source

3. Storage vessel

4. Gas section

5. Gas source valve

6. Conduit system

7. Controller

8. Outlet connection

9. Outlet valve

10. Hose

11. Receiving vessel

12. Sensor

13. Fuel cell

14. Pressure regulation valve

15. Manifold

16. Superior control system

17. Electric vehicle charger

18. Electric vehicle

19. Fuel cell vehicle

20. Energy storage

21. Communication lines

22. Electric load

23. Power supply lines

1. A tube trailer (1) comprising:
a first hydrogen gas source (2a) comprising gaseous hydrogen,
a second hydrogen gas source (2b) comprising gaseous hydrogen,
a controller (7),
an outlet connection (8), and
a fuel cell (13),
wherein said first hydrogen gas source (2a) and said second hydrogen gas source (2b), are fluidly connectable to said outlet connection (8) and to said fuel cell (13) via a conduit system (6), thereby facilitating refueling a receiving vessel (11), when connected to said outlet connection (8), and energy production by said fuel cell (13), and
wherein said fuel cell (13) is electrically connectable to an electric load (22) thereby facilitating supply of electric power to said electric load (22), when electrically connected to said fuel cell (13),
wherein said controller (7) is configured to establish a flow of said gaseous hydrogen in said conduit system (6) from said first hydrogen gas sources (2a) to said fuel cell (13) when the pressure in said first hydrogen gas source (2a) is below a dispensing threshold pressure.

2. A tube trailer (1) according to claim 1, wherein said tube trailer (1) is a mobile hydrogen refueling station.

3. A tube trailer (1) according to any of the preceding claims, wherein said tube trailer (1) is a Multiple Elements Gas Container trailer having a plurality of individually controllable hydrogen gas source (2).

4. A tube trailer (1) according to any of the preceding claims, said tube trailer (1) comprises a plurality of individually controllable gas sections.

5. A tube trailer (1) according to any of the preceding claims, said tube trailer (1) comprises an energy storage (20).

6. A tube trailer (1) according to any of the preceding claims, said energy storage (20) is chargeable from said fuel cell (13).

7. A tube trailer (1) according to any of the preceding claims, said energy storage (20) comprises a plurality of series connected battery modules.

8. A tube trailer (1) according to any of the preceding claims, a first end of a hose (10) is connectable to said outlet connector (8) and a second end of said hose (10) is connectable to a receptable of a fuel cell vehicle.

9. A tube trailer (1) according to any of the preceding claims, said fuel cell (13) is configured to produce electric power while said tube trailer (1) is stationary and disconnected from a truck.

10. A tube trailer (1) according to any of the preceding claims, said tube trailer (1) comprises a water supply.

11. A tube trailer (1) according to any of the preceding claims, said tube trailer (1) comprises an electrolyser.

12. A tube trailer (1) according to any of the preceding claims, said conduit system (6) is at least partly implemented as a manifold (15).

13. A tube trailer (1) according to any of the preceding claims, said conduit system (6) comprises a pressure regulation valve (14) located upstream said fuel cell (13).

14. A tube trailer (1) according to any of the preceding claims, said conduit system (6) fluidly connects said first and second gas sources (2a, 2b) with said outlet connection (8) and said fuel cell (13), wherein said fluid connections are individually controllable by valves.

15. A tube trailer (1) according to any of the preceding claims, said electric load (22) is comprised by said tube trailer (1).

16. A tube trailer (1) according to any of the preceding claims, said electric load (22) is selected from the list comprising: said controller (7), light, a compressor, a cooling system, one or more sensors (12) and one or more valves.

17. A tube trailer (1) according to any of the preceding claims, said electric load (22) is an electric vehicle charger (17).

18. A tube trailer (1) according to any of the preceding claims, said tube trailer (1) is configured to simultaneously refuel a receiving vessel (11) of a fuel cell vehicle (19) and charge a range extender battery of said fuel cell vehicle.

19. A tube trailer (1) according to any of the preceding claims, said dispensing threshold pressure is 15 MPa, preferably 10 MPa, most preferably 5 MPa.

20. A tube trailer (1) according to any of the preceding claims, said controller (7) is configured to determine said dispensing threshold pressure based on pressure in said receiving vessel (11).

21. A tube trailer (1) according to any of the preceding claims, said controller (7) is furthermore configured to establish flow of said gaseous hydrogen in said conduit system (6) from said second hydrogen gas source (2b) to said receiving vessel (11).

22. A tube trailer (1) according to any of the preceding claims, said controller (7) is furthermore configured to establish said flow of gaseous hydrogen to said receiving vessel (11) simultaneously with said flow of gaseous hydrogen to said fuel cell (13).

23. A tube trailer (1) according to any of the preceding claims, said controller (7) is furthermore configured to control said flow of gaseous hydrogen to said fuel cell (13) from said first hydrogen storage vessel (3) when the pressure in said first hydrogen storage vessel (3) is above said dispensing threshold pressure.

24. A tube trailer (1) according to any of the claims 1-23 is controlled according to the method in any the claims 25-46.

25. A method of controlling a gaseous flow in a conduit system (6) of a tube trailer (1) according to a refueling control strategy and a refueling and energy generating control strategy, wherein said conduit system (6) is fluidly connected to a plurality of gas sources (2), an outlet connection (8a) and a fuel cell (13), and wherein said gaseous flow is a hydrogen gas flow controlled by a controller (7) controlling status of a plurality of valves (5, 9, 14) of said conduit system (6),
wherein, during said refueling control strategy, said controller (7) is controlling a gaseous flow from a first gas source (2a) to a receiving vessel (11) connected to said outlet connection (8a) until one of the following conditions are meet:
the pressure of gas inside said first gas source (2a) reaches a dispensing threshold, or
the gaseous flow from said first gas source (2a) to said receiving vessel (11) reaches a determined flow speed,
wherein, during said refueling and energy generating control strategy, said controller (7) is controlling a gaseous flow from said first gas source (2a) to said fuel cell (13),
wherein said controller (7) change control strategy from said refueling control strategy to said refueling and energy generating control strategy when the pressure of gas inside said first gas source (2a) reaches a dispensing threshold pressure.

26. A method according to claim 25, wherein during said refueling control strategy, said fuel cell (13) is supplied with a flow of gaseous hydrogen from one of said plurality of gas sources (2) during discontinuous periods of time.

27. A method according to any of the preceding claims 25-26, said fuel cell (13) is supplied from two different gas sources (2) in two subsequent of said periods of time.

28. A method according to any of the preceding claims 25-27, two subsequent refuelings, controlled according to said refueling control strategy, are both started with gaseous flow from said first gas source (2a).

29. A method according to any of the preceding claims 25-28, an electric load (22) is supplied from an energy storage (20) during said refueling control strategy.

30. A method according to any of the preceding claims 25-29, during said refueling and energy generating control strategy, said fuel cell (13) is continuously supplied with a flow of gaseous hydrogen from said first gas source (2a).

31. A method according to any of the preceding claims 25-30, during said refueling and energy generating control strategy flow of gaseous hydrogen is established simultaneously to both said outlet connection (8) and said fuel cell (13).

32. A method according to any of the preceding claims 25-31, electric energy produced by said fuel cell (13) is used to charge said energy storage (20).

33. A method according to any of the preceding claims 25-32, during said refueling and energy generating control strategy flow of gaseous hydrogen is established from a gas source (2) having a pressure above said dispensing threshold pressure.

34. A method according to any of the preceding claims 25-33, said electric load (22) is supplied with electric power from said fuel cell (13)

35. A method according to any of the preceding claims 25-34, said electric load (22) is supplied with electric power from said energy storage (20).

36. A method according to any of the preceding claims 25-35, said dispensing threshold pressure and/or said determined flow speed is provided to said controller (7) from a superior control system (16) or is predetermined and stored in a data storage associated with said controller (7)

37. A method according to any of the preceding claims 25-36, said controller (7) send a request to said superior control system (16) that a trailer swap is required.

38. A method according to any of the preceding claims 25-37, said determined flow speed is a flow speed of below 20 g/s, preferably below 10 g/s, most preferably below 0.6 g/s.

39. A method according to any of the preceding claims 25-38, said dispensing threshold pressure is dynamically determined by said controller (7) based on a priority of one of an electric vehicle charging control strategy and a fuel cell vehicle refueling control strategy.

40. A method according to any of the preceding claims 25-39, said dispensing threshold pressure is above 50% of rated pressure of said storage vessel (3), preferably above 60% of rated pressure of said storage vessel (3), most preferably above 70% of rated pressure of said storage vessel (3), if said electric vehicle charging control strategy is chosen.

41. A method according to any of the preceding claims 25-40, said dispensing threshold pressure is below 50% of rated pressure of said storage vessel (3), preferably below 60% of rated pressure of said storage vessel (3), most preferably below 70% of rated pressure of said storage vessel (3), if said fuel cell vehicle refueling control strategy is chosen.

42. A method according to any of the preceding claims 25-41, said controller (7) control a first hydrogen gas source (2a) according to said electric vehicle charging control strategy and a plurality of additional hydrogen gas sources (2) according to said fuel cell vehicle control strategy.

43. A method according to any of the preceding claims 25-42, said prioritizing of one of said electric vehicle charging control strategy and said fuel cell vehicle refueling control strategy is made based on a number of fuel cell vehicles simultaneously fluidly connected to said outlet connection (8).

44. A method according to any of the preceding claims 25-43, said prioritizing of one of said electric vehicle charging control strategy and said fuel cell vehicle refueling control strategy is made by a superior control system (16).

45. A method according to any of the preceding claims 25-44, said superior control system use a number of fuel cell vehicles associated with said tube trailer (1) as basis for said prioritising.

46. A method according to any of the claims 25-45 implemented in an apparatus according to any the claims 1.-24.
